(19) United States
(12) Patent Application Publication
(10) Pub. No.: US 2022/0218542 A1
(43) Pub. Date: Jul. 14, 2022

(54) DEPLOYMENT MECHANISM FOR A BARIATRIC RAMP

(71) Applicant: SG Technical Systems Ltd, Market Weighton (GB)

(72) Inventor: Simon CHACKSFIELD, Market Weighton (GB)

(73) Assignee: SG Technical Systems Ltd, Market Weighton (GB)

(21) Appl. No.: 17/573,024

(22) Filed: Jan. 11, 2022

(30) Foreign Application Priority Data
Jan. 12, 2021 (GB) GB2100229.0
Sep. 27, 2021 (GB) GB2113757.5

(51) Int. Cl. A61G 3/06; B60P 1/43

(52) U.S. Cl. CPC A61G 3/061; B60P 1/43

(57) ABSTRACT

A deployment mechanism for a bariatric ramp which has a drive motor pivotally secured to one side of the ramp platform. The deployment mechanism includes a lever located in a housing on the opposing side of the platform ramp. One end of the lever being connected to a platform pivot bar and the other end being connected to a spring secured within the housing.

### RELATED APPLICATIONS

This application claims the benefit of priority of GB Application Nos. GB2100229.0 filed on Jan. 12, 2021, and GB2113757.5 filed on Sep. 27, 2021. The entire contents of the above-referenced applications and of all priority documents referenced in the Application Data Sheet filed herewith are hereby incorporated by reference for all purposes.

### FIELD OF THE INVENTION

The present invention relates to an improved deployment system for a bariatric ramp.

### BACKGROUND TO THE INVENTION

Common bariatric ramps, such as for example the EasyLoad™ ramp manufactured and supplied by the applicant, are driven by a geared electric motor. The motor is controlled by a dedicated controller. One of the controller's functions is to monitor the amps drawn by the motor and if the amperage exceeds approximately 8 A the controller acts to turn the motor off. The motor remains turned off until an operator's releases the open or close switch. When the switch is re-pressed the controller will act to activate the ramp as normal.

The system described is used for obstacle detection. If an object is placed on a moving ramp platform the weight increase will cause the motor current to exceed 8 A and, as a consequence, the controller will act to stop the motor. Similarly, if a person is standing on the platform and their weight will cause the controller to stop the ramp motor.

In the event of an electrical failure the ramp platform can be deployed and stowed manually using a handle (typically an elastic cord). To reduce the force required to manually lift the ramp platform the geared motor is specifically designed to have a low back drive force. This combination provides a high output torque with low output speed so the geared motor can be back driven with relative ease. The low back drive force means that the ramp platform can be easily manually deployed.

Whilst the ramp deployment mechanism described works very well for bariatric ramps within a conventional size range, the mechanism becomes impractical and fails to work for larger, wider ramps, for example a bariatric ramp that is currently being developed by the Applicant which is designed to support a heavier stretcher and which, as a result, is approximately 50% heavier than conventional ramps.

Heavier ramps require a more powerful geared motor which causes other problems when it comes to the manual deployment mechanism. A higher powered motor draws a higher current so will not work with the standard controllers. Furthermore, it takes a greater force to back drive the larger geared motor. If the same motor is used, coupled to a higher ratio gearbox, the current draw can be kept to below the desired limit but the back-drive force will be higher and the ramp will deploy slower as a result. Ramp deployment speed is a significant factor that is taken into account by ambulance operators as operational speed is essential in emergency situations.

Moreover, full drive torque is applied to one side of the platform only, and the increased torque load (which may be 50% higher than standard) risks fatigue cracking along that side.

There is also a commercial necessity for the platform to be manually deployed without any increase in the deployment force required to be applied by the operator compared to the standard ramp. Without further adaptation, this would be impossible due to the increased motor size or gearbox ratio and the increased weight of the ramp.

The present invention seeks to overcome the aforementioned issues by providing a ramp deployment mechanism that applies a torque to effectively compensate for the additional weight of the ramp platform. Further, the mechanism is designed to apply a torque that progressively increases from around zero as the platform lowers from vertical dead centre towards the fully deployed or stowed orientation to compensate for the additional weight.

These features allow use of a motor and controller that is used for conventionally sized ramps and maintains the manual deployment force at the same low level as a standard ramp.

The torque applied by the mechanism should be sufficient to reduce the torque required from the drive motor to a level approximately the same as for standard ramp. Typically, the torque applied to the mechanism should be approximately equal to 50% of the torque of a standard drive motor.

Ramps with spring mechanisms to apply torque are known, for example in US 2011/0088177. In cases though the spring mechanisms are long and external to the housing. As such the mechanism is unprotected from dirt and damage.

The present invention seeks to overcome the problem by providing the spring mechanism in a housing.

The limited space between the pivot block and the moving platform in prior art ramps such as that mentioned above, would not a allow a housing to be placed around the mechanism for protection against the elements and damage. Any housing would need to extend beyond the end of the pivot block, to encompasses the pivot block, which would impinge on the ramp installation.

### STATEMENTS OF INVENTION

According to a first aspect of the invention there is provided a deployment mechanism for a bariatric ramp having a drive motor pivotally secured to one side of the ramp platform, the deployment mechanism including a lever located in a housing on the opposing side of the platform ramp, one end of the lever being connected to a platform pivot bar and the other end being connected to a spring secured within the housing.

Preferably, the lever is located opposite the drive motor pivot point.

Preferably, pivotal movement of a first section of the ramp platform in respect of a second section causes rotation of the pivot bar which, in turn changes the orientation of the lever in respect of the spring.

Preferably, the mechanism further comprises a motor drive control which acts to turn off the drive motor when the first platform section is orientated approximately 20 degrees from horizontal, bearing in mind that the floor of the second section is angled at approximately 12 degrees.

### BRIEF DESCRIPTION OF THE DRAWINGS

The invention will now be described by way of example only with reference to the accompanying diagrammatic drawings, in which:—

FIG. 1 illustrates a bariatric ramp with a ramp deployment mechanism constructed in accordance with the invention;

FIG. 2 is an exploded view of the mechanism;

FIGS. 3 and 4 illustrate the deployment mechanism in use; and

FIG. 5 is an exploded view of an alternative tension spring mechanism suitable for use with the invention.

### DETAILED DESCRIPTION OF THE INVENTION

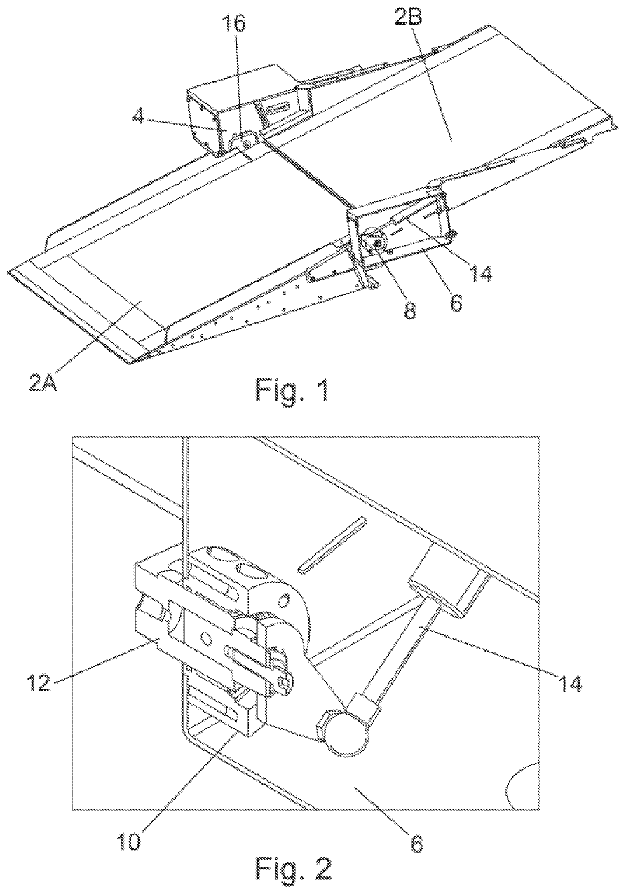

FIG. 1 shows a non-conventional sized bariatric ramp with an improved ramp deployment mechanism suitable for the additional weight of the ramp system 2.

The ramp system 2 includes a platform section 2A tiltable with respect to pan section 2B. Pan 2B includes housing 4 in which is housed a geared motor (not shown). Platform 2A is pivotally secured to housing 4 and extends across pan 2B.

On the other side of ramp pan 2B, opposite the motor housing 4, is a further housing 6 in which is located a lever 8 secured at one end to a bearing housing 10 through which is connected a pivot bar 12 providing the mechanism to raise the platform 2A. The other end of the lever 8 is attached to a spring 14 secured within the lever housing 6. The spring may be gas traction spring as shown in FIG. 1 or could alternatively be one or more tension springs.

The lever 8 is positioned opposite the pivot point 16 of the drive motor.

The spring 14 is hard wearing and heavy duty and, in use, acts to assist the drive motor, or the operator during manual deployment, to stow or deploy the ramp platform 2A.

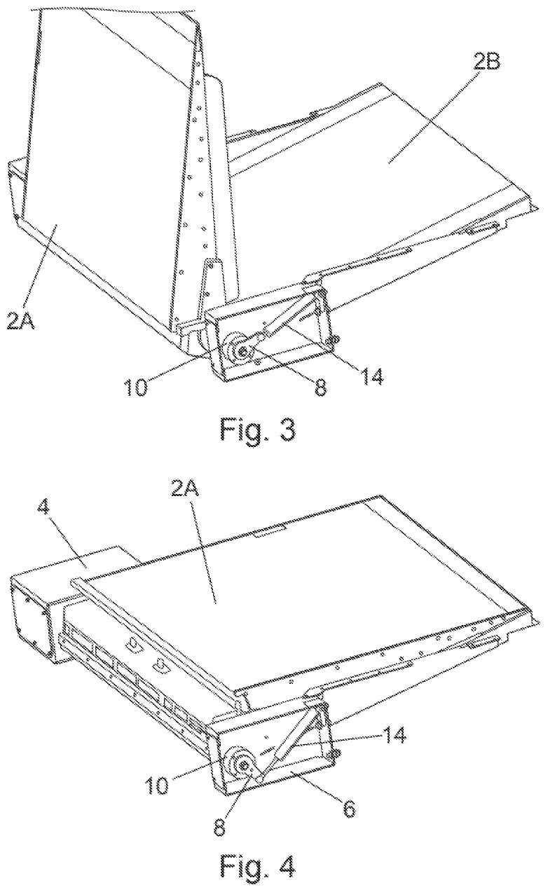

To this end, and as can be seen in FIGS. 3 and 4, as the platform 2A lifts and tilts in respect of the pan 2B, the pivot bar 12 rotates causing the lever 8 to orientate towards the spring 14 which then provides a controlled pulling force to assist continued raising of the platform 2A.

Conversely, once the platform 2A passes the top dead centre, continued rotation of the pivot bar 12 causes the lever 8 to orientate away from the spring 14 which then acts to counteract the torque generated by the platform 2A as it lowers towards its end, stowed, position. When platform 2A closed, the process described above is reversed.

By reducing the torque required from the drive motor to lift the platform 2A, a smaller sized power drive motor can be used. In the case of manual deployment, the required force is reduced to a level associated with conventional ramps.

Once the platform 2A reaches approximately 20 degrees from its fully open or fully closed orientation, a drive controller (not shown) acts to turn the drive motor off at which time the platform 2A continues to lower under gravity to drive the motor, acting then as a generator.

The controller includes a resistor though which generated electricity is routed. The resistor causes a resistance to the drive motor rotational movement thereby slowing the motor and the movement of the platform 2A. Consequently, movement of the platform 2A decelerates as it reaches its fully closed or fully open orientation ensuring that the platform 2A does not slam open or closed.

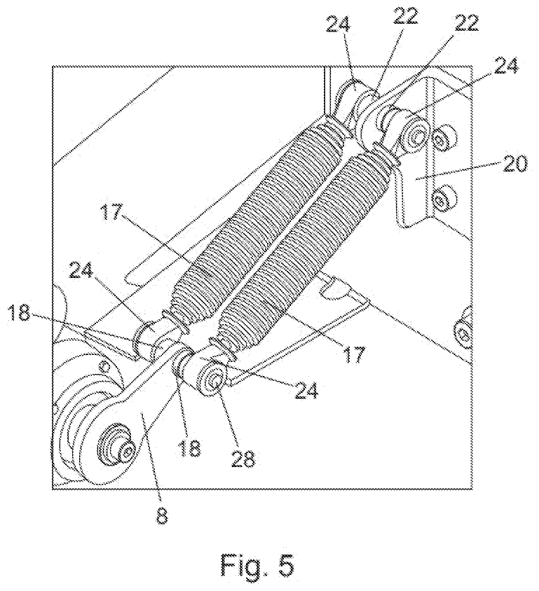

FIG. 5 is an exploded view illustrating an alternative spring mechanism of the invention.

In this embodiment, two tension springs 17 are used orientated side-by-side to provide the required strength and extension range required for the deployment mechanism.

To this end, the lever 8 has side extensions 17 on opposing surfaces each to receive the end of a respective spring 17. The other end of the springs 17 are secure to a bracket 20 secured to the housing 6 which has similar opposing side extensions 22.

Each side extension 18, 22 provides a shaft and each end of both springs 17 has an end connector 24 which extends around the side extension 18, 22 to be rotatable about its shaft. The connector 24 is then held on the shaft by a retaining circlip and washer 28.

To provide a smooth rotation and reduce friction, each connector 24 includes a polymer sleeve bearing.

The single spring may be used, and which may also incorporate an end connector as described.

1. A deployment mechanism for a bariatric ramp which has a drive motor pivotally secured to one side of the ramp platform, the deployment mechanism including a lever located in a housing on the opposing side of the platform ramp, one end of the lever being connected to a platform pivot bar and the other end being connected to a spring secured within the housing.

2. A mechanism according to claim 1, wherein the lever is located opposite the drive motor pivot point.

3. A mechanism according to claim 1, wherein pivotal movement of a first section of the ramp platform in respect of a second section causes rotation of the pivot bar which, in turn changes the orientation of the lever in respect of the spring.

4. A mechanism according to any one of claim 1, further comprising a motor drive control which acts to turn off the drive motor when the first platform section is orientated approximately 20 from horizontal.
